(19) United States
(12) Patent Application Publication
(10) Pub. No.: US 2010/0138597 A1
(43) Pub. Date: Jun. 3, 2010

(54) Information Processing System, System Controller, and Memory Control Method

(75) Inventor: Hiroaki Komaki, Tachikawa-shi (JP)

Correspondence Address: BLAKELY SOKOLOFF TAYLOR & ZAFMAN LLP, 1279 OAKMEAD PARKWAY, SUNNYVALE, CA, 94085-4040, US

(73) Assignee: Kabushiki Kaisha Toshiba, Tokyo (JP)

(21) Appl. No.: 12/510,079

(22) Filed: Jul. 27, 2009

(30) Foreign Application Priority Data
Nov. 28, 2008 (JP) 2008-305510

(51) Int. Cl. G06F 12/06; G06F 13/28

(52) U.S. Cl. 711/105; 711/E12.084

(57) ABSTRACT

According to one embodiment, an extreme data rate DRAM is a DRAM resetting data thereof in response to a reset signal. When power is initially supplied to a system, a system controller outputs the reset signal to the extreme data rate DRAM in response to a reset signal input from a memory controller through a level shifter. When shutting down power of a system while suspending data stored in the extreme data rate DRAM, the system controller shuts down power of the memory controller while maintaining supply of power to the extreme data rate DRAM in response to the reset signal input from the memory controller through the level shifter.

### CROSS-REFERENCE TO RELATED APPLICATIONS

This application is based upon and claims the benefit of priority from Japanese Patent Application No. 2008-305510, filed Nov. 28, 2008, the entire contents of which are incorporated herein by reference.

### BACKGROUND

1. Field

The present invention relates to a suspend-to-RAM (STR) processing technique in an information processing system having XDR DRAM (registered trademark) as a main memory.

2. Description of the Related Art

As regards a means for effecting a high-speed activation of a system such as a computer, a technique called an STR system in which a main memory (typically, synchronous dynamic random access memory [SDRAM]) is always brought into a powered state to store a system state immediately before degeneration (partial shutdown of power supply) of the system has been known. The STR system involves a mode for stopping power supply to almost all devices such as a CPU and a hard disk while storing a present state in the main memory. Since the main memory stores data of a state in which an OS is activated, the OS is not re-activated for returning and the OS may return to the state immediately before suspend as it was.

The STR system involves a suspend mode in which consumed power during suspend and the time required to return to the state before suspend are well balanced. For instance, although a suspend-to-disk (STD) for evacuating the data to a hard disk to shut down power supply of almost all devices has nearly the same principle as that of the STR, the STR system requires a shorter time for returning because the memory has an access speed which is far faster than that of the hard disk. While the STR system supplies the power to the memory and an STD system does not supply the power to the hard disk, it does not pose a serious problem because the power consumed by the memory is relatively small.

In the system disclosed in Jpn. Pat. APPln. KOKAI Publication No. 2007-504553, before resetting the system, a memory controller determines if the system is in an STR state. The memory controller can clear the data in accordance with determination that a processor is not in the STR state.

Recently, as regards a processor that is a main device of a platform for enjoying real-time content including a moving image with high resolution and multi-channel sound through a high-level human interface, Spurs Engine (SPE) (registered trademark) has been developed. This processor is optimized for processing in a multi-media system and a distributed computing environment. In the processing in the multimedia system, the SPE effects approximately ten times as much as performance of a conventional processor mounted on a personal computer, etc.

A recently data rate of a dynamic RAM (DRAM) has become extremely high, and may reach several gigahertz. The XDR DRAM is useful for such a high data rate DRAM. In the processor given above, STR processing for the XDR DRAM is defined as a concept. As different from implementing the STR on a conventional SDRAM (DDR2 DRAM), in a case of the XDR DRAM, a system controller side controlling an STR control circuit has to recognize a control state on a memory controller side operating an “Extreme I/O” (XIO) memory interface in control of system activation such as RSTn control in “Cold Boot” and SCK/CMD control in “Warm Boot”. However, such a recognition means has not been defined concretely.

In the STR processing of a memory system using the conventional XDR DRAM, a required time for activation of the “Warm Boot” is extremely long; accordingly, speed-up of the STR processing is desired.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary block diagram depicting a configuration of an information processing system regarding one embodiment of the invention;

FIG. 2 is an exemplary view depicting a detailed circuit surrounding a system controller 11, a memory controller 12, XDR DRAM 13 and an STR control circuit 14;

FIG. 3 is an exemplary block operation view depicting STR control in “Cold Boot”;

FIG. 4 is an exemplary block operation view depicting STR control in a case where power supply is shut down in setting suspend;

FIG. 5 is an exemplary block operation view depicting STR control in “Warm Boot”; and

FIG. 6 is an exemplary view depicting a circuit achieving speed-up of XDR DRAM reset control in the “Cold Boot”.

### DETAILED DESCRIPTION

Various embodiments according to the invention will be described hereinafter. In general, according to one embodiment of the invention, in STR processing of information processing system using XDR DRAM, activation (power-on) processing and degeneration (partial shutdown of power) processing for the system are implemented in response to a reset (RST) signal from a memory controller. In response to the RST signal, a processing state on a memory controller side which is necessary for the STR processing is transmitted to a system controller side. The system controller executes the activation processing and the regeneration processing of the system in response to the RST signal.

As a result, in STR processing of a memory system using the XDR DRAM, overhead of processing which is necessary to transmit the processing state on the memory controller side to the system controller side is reduced, and the required time for the activation processing and the degeneration processing can be shortened.

The following will describe one embodiment the invention with reference to the drawings.

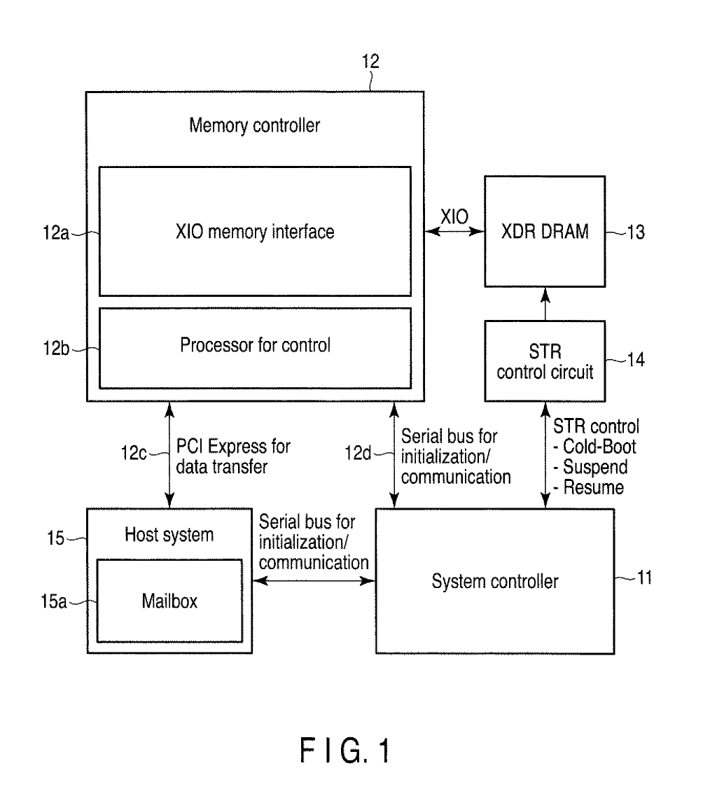

FIG. 1 shows a block diagram illustrating a configuration of an information processing system regarding the one embodiment of the invention.

The system includes a system controller 11, a memory controller 12, an extreme data rate DRAM (XDR DRAM) 13, an STR control circuit 14 and a host system 15.

The system controller 11 performs overall control of the system. The system controller 11 performs, for example, initialization of the memory controller 12, initialization of the host system 15, setting of Vref_FETE, RSTn, and SCK_BJT of the STR control circuit 14, communication with the memory controller 12 via a mailbox 15a, and monitoring the present system. In this embodiment, as mentioned below, the system controller 11 monitors an STR processing state of the memory controller 12 (XIO memory interface 12a) through a RST (reset) terminal output signal from the memory controller 12.

The memory controller 12 is, for example, a memory controller installed in a general-purpose processor composed of a multi-core processor or a single processor of the above. Here, such a general-purpose processor is referred to as the memory controller 12. The memory controller 12 includes an XIO memory interface 12a, a processor for control 12b, and a PCI express for data transfer 12c (a high rate bus for communication with the host system 15), and serial bus for initialization/communication 12d. The memory controller 12 operates for computation such as image processing for achieving a system function.

The XDR DRAM 13 is a main memory of the memory controller 12. The STR control circuit 14 is composed an FET for Vref control, a voltage dividing resistor for RSTn control, and an NPN-BJT for SCK control as described below.

The host system 15 is a south bridge, namely a system-on-chip (SoC) with I/O of the memory controller 12 integrated therein. The host system 15 includes a mailbox 15a, an SRM (not shown) for communication between the system controller 11 and the memory controller 12, and a serial bus for initialization/communication 15b.

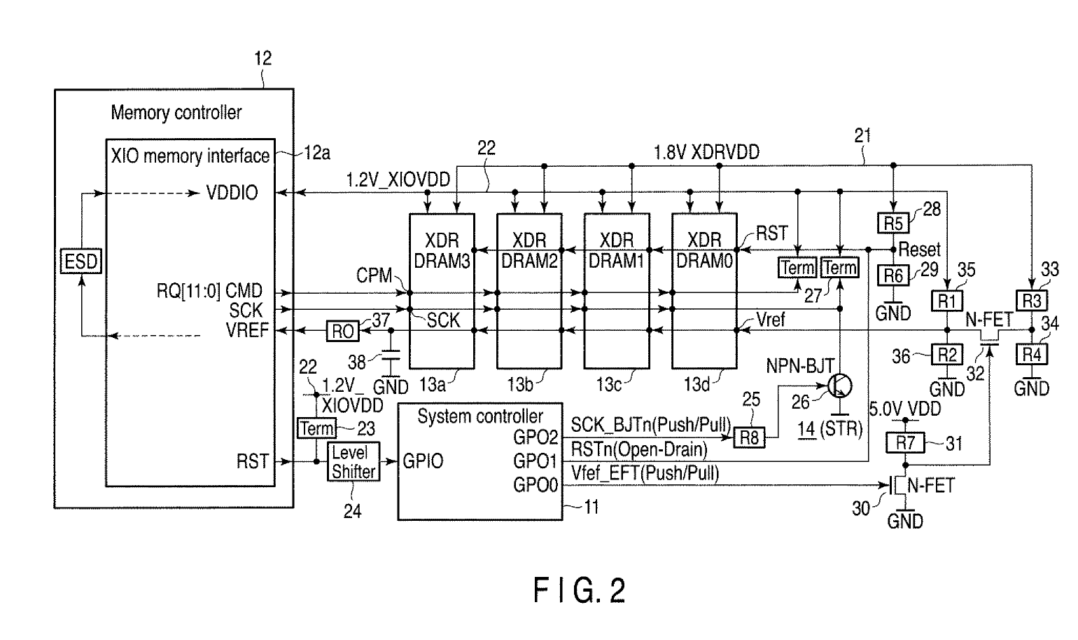

FIG. 2 shows a surrounding detailed circuit of the system controller 11, the memory controller 12, the XDR DRAM 13, and the STR control circuit 14. To simplify the description, data busses, address buses and other signal lines are omitted.

As regards the XDR DRAM 13, in this embodiment, four XDR DRAMS 13a to 13d are disposed. Each XDR DRAM 13a to 13d may arbitrarily set each bit configuration such as eight bits, and may set numbers (0 to 3) for identifying them, respectively. In FIG. 2, a “Term” 23 indicates a terminal resistor (pull-up resistor). A memory cell power supply line (also referred to as a core power supply) 21 supplies, for example, a voltage of 1.8V. An I/O power supply line (also referred to as an I/O power supply) 22 supplies a voltage, for example, of 1.2V. The STR control circuit 14 includes a resistor 25, an NPN bipolar transistor 26, an N-channel FET 30, a resistor 31 and an N-channel FET 32.

The RST (reset) terminal of the memory controller 12 is connected to the I/O power supply line of 1.2V through the resister 23, and also connected to a general-purpose input 0 (GPI0) of the system controller 11 through a level shifter 24. The level shifter 24 converts RST output amplitude (1.2V/0V) the memory controller 12 into appropriate input amplitude (3.3V/0V) of the system controller 11.

A general-purpose output 0 (GPO0) terminal of the system controller 11 is connected to the gate of the FET 30. One current terminal of the transistor 30 is connected to a power supply line of 5.0V through the resistor 31, and also connected to the gate of the FET 32, and the other current terminal of the transistor 30 is connected to the ground GND. One current terminal of the transistor 32 is connected to the power supply line 21 through a resistor 33, and also connected to the GND through a resistor 34. The other current terminal of the transistor 32 is connected to the power supply line of 1.2V through a resistor 35 and also connected to the GND through a resistor 36.

A GPO1 terminal of the system controller 11 is connected to each RST terminal of the XDR DRAMs 13a to 13d. The GPO1 terminal is connected to the power supply line 21 of 1.8V through a resistor 28 and also connected to the GND through a resistor 29.

A GPO2 terminal of the system controller 11 is connected to the base of the bipolar transistor 26 through the resistor 25. The collector of the transistor 26 is connected to each SCK terminal of the XDR DRAMs 13a to 13d and to an SCK terminal of the memory controller 12, and also connected to the power supply line 22 of 1.2V through a resistor 27.

The following will describe operations of the embodiment.

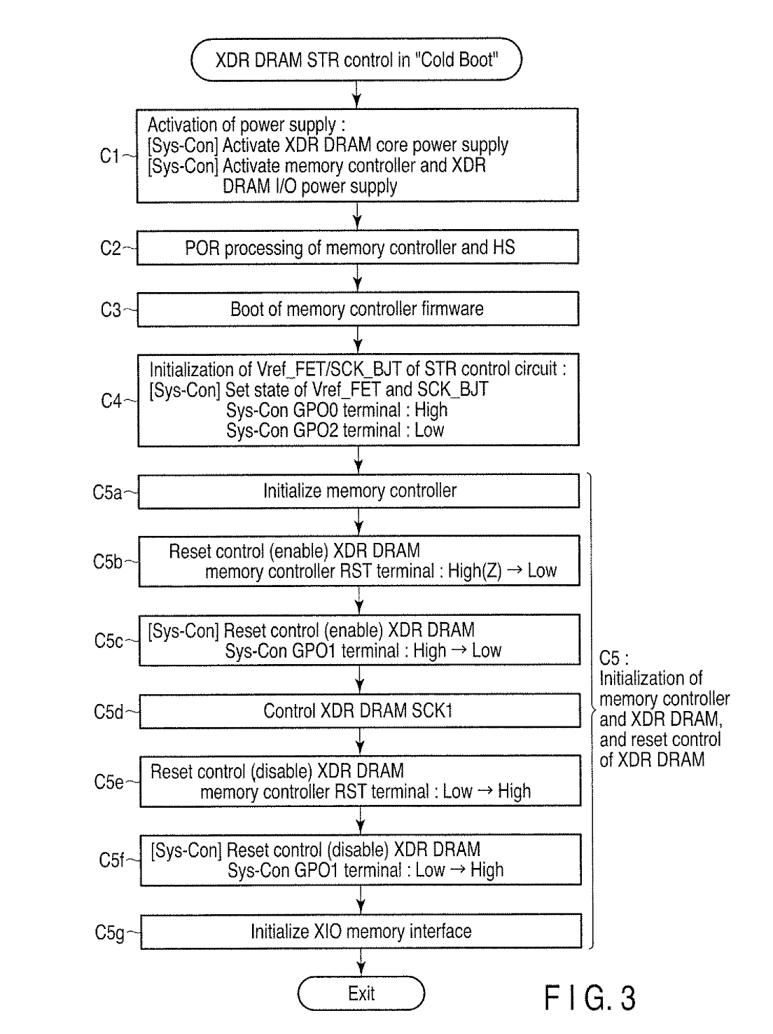

The STR control of the XDR DRAM 13 in the “Cold Boot” will be firstly described with reference to the block operation view of FIG. 3. In the “Cold Boot”, namely, in initial turning on a power supply after shipment from a factory, the STR control for the XDR DRAM 13 will be performed in the procedures below.

When the power supply is turned on in Block C1, the system controller [Sys-Con] 11 supplies power through the XDR DRAM core power supply (1.8V_XDR VDD) 21, and the memory controller and I/O power supply (1.2V_XIO VDD) 22.

Power on Reset (POR) processing of the memory controller 12 and the host system [HS] 15 are performed in Block C2.

“Boot” of firmware of the memory controller 12, namely, running of the firmware from the beginning is implemented in Block C3 (hereinafter, firmware of the memory controller 12 is referred to as memory controller 12 firmware).

Initial setting of the Vref_FET and the SCK_POT in the STR control circuit 14 is performed in Block C4. In other words, the system controller 11 sets the GPO0 terminal (Vref_FET) to a high level, and sets the GPO2 terminal (SCK_BJT) to a low level.

The initializations of the memory controller 12 and the XDR DRAM 13 and the XDR DRAM reset control are performed in Block C5. Hereinafter, the details of Block C5 are explained as Blocks C5a to C5g.

Block C5a: The memory controller 12 firmware initializes the memory controller 12.

Block C5b: The memory controller 12 firmware performs the XDR DRAM reset control (enables the XDR DRAM 13). That is, the memory controller 12 firmware sets the RST (reset) terminal of the memory controller 12 to the low level. This RST signal is input to the GPI0 terminal of the system controller 11 as a low-level signal through the level shifter 34.

Block C5c: The system controller 11 performs XDR DRAM reset control (enables the XDR DRAM 13). That is, the system controller 11 sets the GPO1 terminal (RST) to the low level in response to the low level of the GP10 terminal. This RST signal is input to the RST terminals of the XDR DRAMs 13a to 13d to reset them. At this moment, data bit configuration, numbers (addresses), etc., of the XDR DRAMs 13a to 13d are reset, and the XDR DRAMs 13a to 13b can not be used; however, the data stored in a RAM main unit is not deleted.

Here, the system controller 11 is needed to complete the processing for setting the GPO1 terminal (RST) to the low level within a predetermined time (e.g., 1 ms) after change of the RST terminal of the memory controller 12 from the high level to the low level. Because, taking a time for this processing longer than the predetermined time causes possibility of making the memory controller 12 start operate, for example, of writing wrong data to the XDR DRAM 13.

Block C5d: The software of the memory controller 12 (hereinafter, referred to as memory controller 12S/W) performs SCK control for the XDR DRAM 13.

Block C5e: The memory controller 12S/W performs XDR DRAM reset control (disables the XDR DRAM 13). That is, the memory controller 12S/W changes the RST terminal of the memory controller 12 from the low level into a high impedance (high level). This signal is input to the GPI0 terminal of the system controller 11 through the level shifter 34 as the high-level signal.

Block C5f: The system controller 11 performs XDR DRAM reset control (disables the XDR DRAM 13). That the system controller 11 sets the GPO1 terminal (RST) to the high impedance in response to the high level of the GPI0 terminal. Here, the system controller 11, as described above, is needed to complete the processing of setting the GPO1 terminal (RST) to the high impedance in response to the high level of the GPI0 terminal within a predetermined time (e.g., 1 ms) after change of the RST terminal of the memory controller 12 from the low level to the high level.

C5g: The memory controller 12S/W initializes the XIO memory interface 12a.

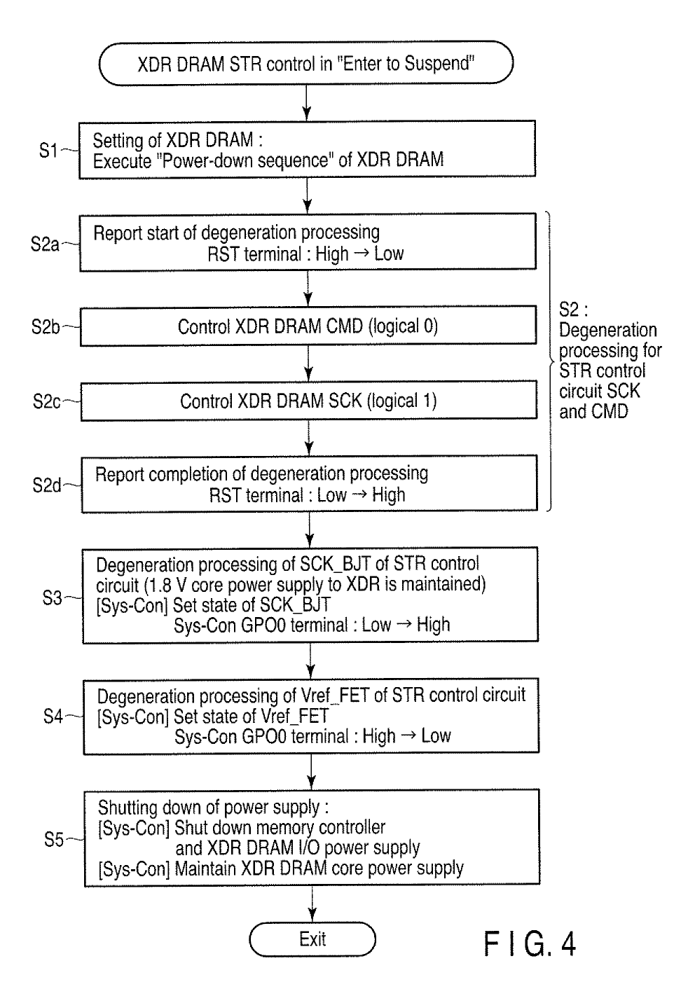

As regards the STR control, upon turning off power supply (Enter to Suspend) to set suspend, namely, a case of shutting down the Power of the system while suspending the data stored in the DRAM as it is will be described by referring to the block operation view of FIG. 4.

In Block S1, the setting for the XDR DRAM 13 is performed. That is, the memory controller 12 firmware executes “Power-down Sequence” of the XDR DRAM 13. As a result, the XDR DRAM 13 is brought into a self refresh mode with less power consumption.

In Block S2, the degeneration processing for the serial clock (SCK) and command (CMD) of the STR control circuit 14 are performed. Namely, processing for separating the memory controller 12 from the XDR DRAM 13, and turning off the power supply of the memory controller 12 is performed. Hereinafter, the details of Block S2 will be described by dividing Block S2 into Blocks S2a-S2d.

Block S2a: The memory controller 12 firmware reports the start of the degeneration to the system controller 11 by changing the RST terminal of the memory controller 12 from the high impedance to the low level.

Block S2b: The memory controller 12 firmware fixes the logic of the CMD of the XDR DRAM 13 to logical 0.

Block S2c: The memory controller 12 firmware fixes the logic of the SCK of the XDR DRAM 13 to logical 1. In this way, fixing the logic of the CMD and SCK enables fixing the output levels of the CMD terminal and SCK terminal and enables preventing noise occurrence in later processing.

Block S2d: The memory controller 12 firmware sets the RST terminal from the low level to the high impedance (high level) to report the completion of the regeneration processing to the system controller 11. In this way, in a case of the shutdown of the power supply in suspend setting; the RST signal of the memory controller 12 functions as a signal showing the start and completion of the degeneration processing of the memory controller 12.

In Block S3, SCK_BJT regeneration processing of the STR control circuit 14 is implemented. That is the system controller 11 responds to the high level of GPI0 input terminal to set the GPO2 terminal (SCK_BJTn) from the low level to the high level. Thereby, the bipolar transistor 26 may prevent noise interfusion into the SCK signal line.

In Block S4, Vref_FET regeneration processing of the STR control circuit 14 is implemented. That is, the system controller 11 sets the GPO0 (Vref_FET) terminal from the high level to the low level. Thereby, the FET 30 is turned off, and the FET 32 is also turned off.

In Block S5, power shutdown processing is implemented. That is, the system controller 11 shuts down the power supply (1.2V_XIO VDD) 22 for the memory controller 12 and the XDR DRAM I/O. Here, the system controller 11 maintains the XDR DRAM core power supply (1.8V_XDR VDD) 21. Thereby, the data stored in the XDR DRAM 13 is suspended.

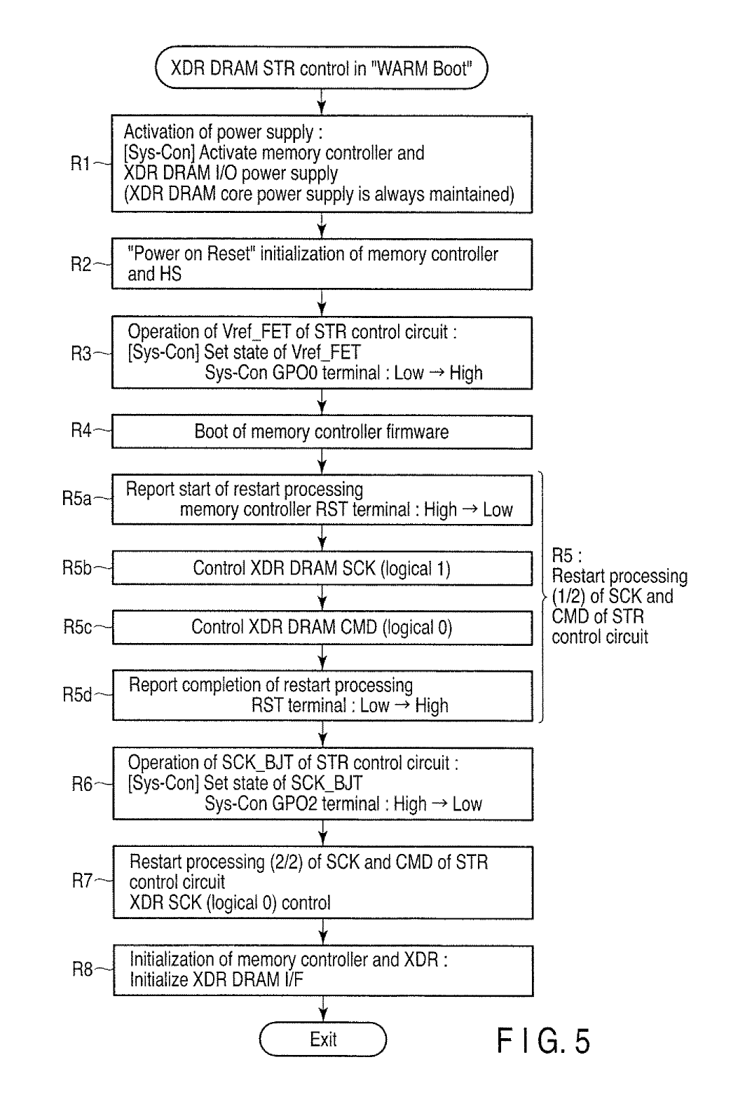

Next, STR control of the XDR DRAM 1 during “Warm Boot” so-called “Resume” will be described with reference to the block operation view of FIG. 5.

When the “Warm Boot”, namely, power is supplied to the system in a suspend state (a state where the XDR DRAM core power supply has been maintained), the STR control for the XDR DRAM is performed through the following procedures.

When power is supplied, the system controller 11 turns on the I/O power supply (1.2V_XIO VDD) 22 of the memory controller 12 and the XDR DRAM in Block R1. Here, the power supply of system controller 11 and the core power supply 21 of the memory controller 12 are always maintained.

In Block R2, “Power on Reset” (POR) initializing processing (reset, etc., of each register) for the memory controller 12 and the host system 15 are performed.

In Block R3, the Vref_FET operation of the STR control circuit is implemented. That is, the system controller 11 changes the GPO0 terminal (Vref_FET) from the low level to the high impedance (level). Thereby, the FET 30 is turned on, and the FET 32 is also turned on.

In Block R4, the “Boot” of the memory controller 12 firmware is performed, in other words, the program is executed from the beginning of the memory controller 12 firmware.

In Block R5, restart processing (½) of the SCK/CMD of the STR control circuit 14 is implemented. Hereinafter, the details of Block R5 will be described as Blocks Ra-Rd.

Block 5a: The memory controller 12 firmware changes the RST terminal of the memory controller 12 from the high impedance to the low level to report the start of the restart processing to the system controller 11.

Block R5b: The memory controller 12 firmware fixes the logic of the SCK of the XDR DRAM 13 to logical 1.

Block R5c: The memory controller 12 firmware fixes the logic of the CMD of the XDR DRAM 13 to logical 0.

Block R5d: The memory controller 12 firmware sets the RST terminal from the low level to the high impedance (high level) to report the completion of the restart to the system controller 11. In this way, during “Warm Boot”, the RST signal of the memory controller 12 functions as a signal showing the start and completion of the restart processing of the memory controller 12.

In Block R6, SCK_BJT operation of the STR control circuit is implemented. That is, the system controller 11 responds to the high level at the GOI0 terminal to sets the GPO2 terminal from the high level to the low level, and then, the bipolar transistor 26 is turned off. As mentioned above, the system controller 11 is needed to complete this processing within the predetermined time (e.g., 1 ms) after change of the RST terminal of the memory controller 12 from the high level to the low level.

In Block R7, SCK/CMD restart processing (2/2) of the STR control circuit is implemented. That is, the memory controller 12 firmware fixes the logic of the SCK of the XDR DRAM 13 to logical 0. A serial-bus between the XIO memory interface 12a and the XDR DRAM 13 is returned to normal operations.

In Block R8, the memory controller 12 and the XDR DRAM 13 are initialized. That is, the memory controller 12 firmware initializes the XIO memory interface 12a.

As mentioned above, the information processing system regarding the one embodiment of the invention, includes the XDR DRAM 13 for performing data reset in response to the input of the reset signal; the memory controller 12 for controlling the XDR DRAM 13 to write and read the data; and the system controller 11 for performing STR processing of the XDR DARM 13. In any time when the “Cold Boot” (initial supply of power) is implemented, when power is shut down in suspend setting, and when the “Warm Boot” (normal supply of power) is performed, the memory controller 12 outputs the RST signal (low). In a case of cold Boot, the system controller 11 determines that the RST signal input from the memory controller 12 is data reset signal, and outputs a reset signal to the XDR DRAM 13. Therefore, the XDR DRAM 13 reset data thereof. In a case of shutdown of power in suspend setting, the system controller 11 determines that the RST signal input from the memory controller 12 is a report of the degeneration mode, and shuts down the power supply to the memory controller 12 while maintaining the supply of power to the XDR DRAM 13. Thus, in a system including the DRAM such as the XDR DRAM with a reset function, the STR processing may be performed in a short time.

The following will describe speed-up of the reset control of the XDR DRAM 13.

To speed up the reset control of the XDR DRAM 13 for the “Cold Boot”, the system controller 11 does not reset the XDR DRAM 13 from the GOP1 terminal, but the memory controller 12 may directly reset the XDR DRAM 13.

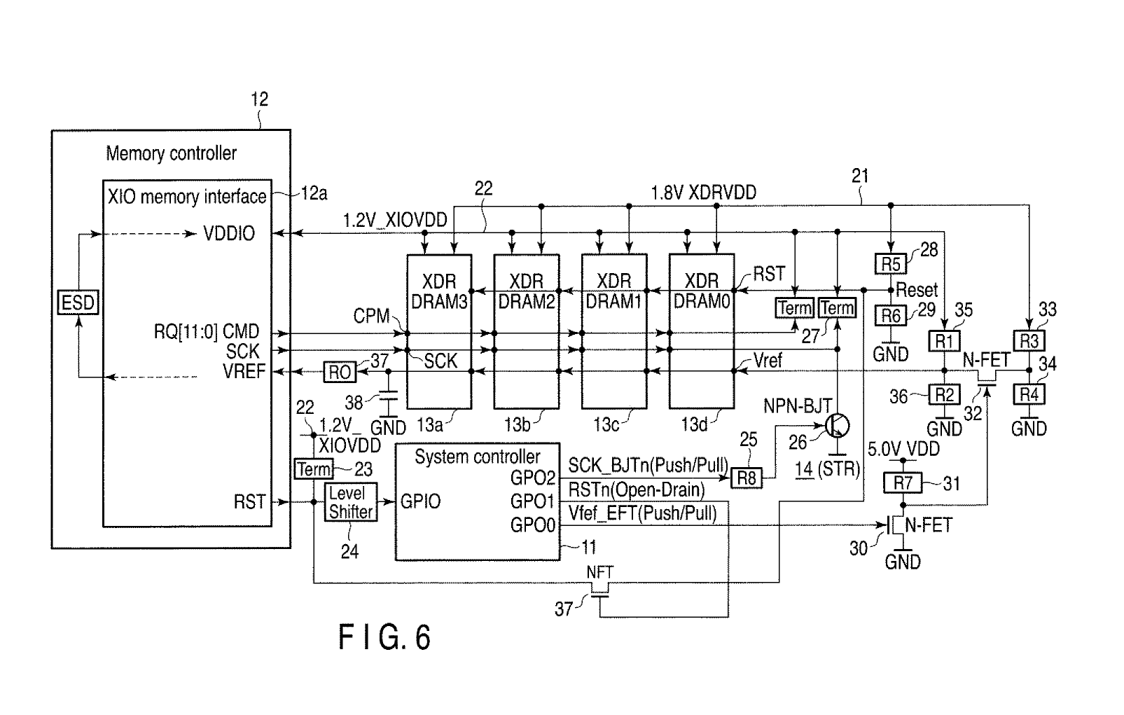

FIG. 6 shows a circuit for achieving the speed-up of the reset control of the XDR DRAM 13. In comparing the circuit of FIG. 6 with the circuit of FIG. 2, the circuit of FIG. 6 is added with an FET 37. The FET 37 is connected among the RST terminal of the memory controller 12 and the XDR DRAMs 13a-13d, and the gate of the transistor 37 is connected to the GPO1 terminal of the system controller 11.

When “Cold Boot” is performed, a level GPO1 terminal of the system controller 11 is a low level. The RST terminal of the memory controller 12 outputs a low-level signal as a reset signal. Thereby, the memory controller 12 can directly reset the XDR DRAMs 13a-13d through the RST terminal, and effect speed-up of the XDR DRAM reset control. In this embodiment, when shutting down power supply in suspend setting, and when performing the “Warm Boot”, the GPO1 terminal of the system controller 11 maintains the high level.

The aforementioned description has made for the embodiment of the invention, and does not limit the device and method of the invention; various modifications may be easily realized.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information processing system comprising:
a DRAM which resets data thereof in response to a reset signal input;
a memory controller which controls the DRAM to write and read the data; and
a system controller which performs “Suspend-to-RAM” processing of the DRAM, wherein
the system controller comprises:
a unit configured to output a reset signal to the DARM in response to a reset signal input from the memory controller when power is initially supplied to the system; and
a unit configured to shut down power to the memory controller while maintaining supply of power to the DRAM in response to the reset signal input from the memory controller when shutting down the power supply to the system while suspending data stored in the DRAM.

2. The system of claim 1, further comprising:
a level shifter disposed between the memory controller and the system controller, wherein the reset signal is transmitted from the memory controller to the system controller through the level shifter.

3. The system of claim 1, wherein the DRAM is an extreme data rate DRAM.

4. A system controller for performing “Suspend-to-RAM” processing of a system comprising a DRAM resetting data thereof in response to a reset signal input; and a memory controller controlling the DRAM to write and read the data, comprising:
a unit configured to output the reset signal to the DARM in response to a reset signal input from the memory controller when power is initially supplied to the system; and
a unit configured to shut down power to the memory controller while maintaining supply of power to the DRAM in response to the reset signal input from the memory controller when shutting down the power supply to the system while suspending data stored in the DRAM.

5. A memory control method for a “Suspend-to-RAM” in an information processing system comprising a DRAM; a memory controller; and a system controller, comprising:
outputting a reset signal to the DRAM in response to a reset signal input from the memory controller when power is initially supplied to the system; and
shutting down power to the memory controller while maintaining supply of power to the DRAM in response to the reset signal input from the memory controller when shutting down the power supply to the system while suspending data stored in the DRAM.

6. The method of claim 5, wherein the reset signal is transmitted from the memory controller to the system controller through a level shifter.

7. The method of claim 5, wherein the DRAM is an extreme data rate DRAM.
